(19) United States
(12) Patent Application Publication
(10) Pub. No.: US 2026/0085911 A1
(43) Pub. Date: Mar. 26, 2026

(54) METHOD AND SYSTEM FOR TARGET DESIGNATION AND AUTONOMOUS LAUNCH CONTROL USING A SECURE ELECTRONIC NETWORK

(71) Applicant: Caleb Crye, Brooklyn, NY (US)

(72) Inventor: Caleb Crye, Brooklyn, NY (US)

(21) Appl. No.: 19/336,185

(22) Filed: Sep. 22, 2025

Related U.S. Application Data
(60) Provisional application No. 63/697,177, filed on Sep. 20, 2024.

(51) Int. Cl. F41G 7/00; B64U 70/92; B64U 101/15; F41G 7/34

(52) U.S. Cl. CPC F41G 7/007; B64U 70/92; F41G 7/34; B64U 2101/15; B64U 2201/20

(57) ABSTRACT

A method of executing a launch of a launch unit comprises selectively forming a secure network of electronic devices including at least a designator interface configured to generate a visual display of a target and receive a user input designating the target, and respective electronic devices associated with portable launch assemblies. The designator interface ascertains a second electronic device as being available for launch, and provides via the secure network a real-time authorization signal to the second electronic device available for launch, wherein the launch unit is autonomously launched from the associated launch assembly based at least upon the real-time authorization signal. The designator interface further may capture impact information corresponding to a point of impact of the launch unit within a field of view thereof.

A portion of the disclosure of this patent document contains material that is subject to copyright protection. The copyright owner has no objection to the reproduction of the patent document or the patent disclosure, as it appears in the U.S. Patent and Trademark Office (USPTO) patent file or records, but otherwise reserves all copyright rights whatsoever.

### FIELD OF THE DISCLOSURE

The present disclosure relates to a method of executing a launch, and more particularly to apparatuses, systems, and methods of executing a launch via a designator interface.

### BACKGROUND

Accurately designating and engaging targets is crucial to ensure mission success and minimize collateral damage. Known target designation and launch systems often suffer from significant drawbacks due to their reliance on centralized control. These systems introduce latency, reduce operational flexibility, and create single points of failure, making them vulnerable in dynamic environments. Moreover, known systems lack the integration of advanced electronic devices and interfaces within portable launch assemblies. This deficiency hampers systems' operational capabilities, limiting the ability to autonomously execute complex tasks like target designation and munitions launch. Real-time data integration from diverse sources like surveillance sentries, aerial vehicles, and orbital instruments is often insufficient or non-existent, leading to suboptimal decision-making and execution. Further, known systems are not able to provide a cohesive and efficient method for combining and utilizing real-time data to determine optimal launch parameters. These deficiencies result in inaccuracies and inefficiencies in munitions deployment, potentially compromising mission outcomes.

There is a need to provide apparatus, methods, or systems that overcome the foregoing limitations. The present disclosure provides an inventive method for executing the launch of at least one portable launch assembly, fully integrated within a graphical designator interface of a target designator. The present disclosure provides a method that forms a secure network of electronic devices, processes target and launcher signals in real-time, and autonomously launches munitions based on user inputs and dynamic data. The present disclosure significantly enhances the precision and reliability of munitions deployment, thereby improving overall mission effectiveness and operational resilience.

### BRIEF SUMMARY

The present disclosure provides a novel portable launch assembly. Specifically, the present disclosure provides a novel method and system for executing an operation for the portable launch assembly. Aspects of apparatuses, methods, and systems of the present disclosure provide a solution to the shortcomings above.

In some aspects, the techniques described herein relate to a method of executing a launch of at least one portable launch assembly configured to launch a launch unit, the method including: selectively forming a secure network including a plurality of electronic devices, where a first electronic device of the plurality of electronic devices includes a designator interface configured to generate a visual display of a target to a user and receive a user input designating the target; transmitting, via the secure network and from a data source of the plurality of electronic devices, a target signal to the first electronic device; displaying, via the designator interface, a field of view associated with the target signal; designating, via the designator interface, the target within the field of view; receiving, at the first electronic device and via the secure network, a launcher signal representative of at least one of a second electronic device of the plurality of electronic devices, the second electronic device is associated with the at least one portable launch assembly, the launch unit, or a combination thereof; ascertaining, via the designator interface, the second electronic device available for launch, wherein ascertaining is at least based on the target signal and the launcher signal; providing, via the designator interface and the secure network, a real-time authorization signal to the second electronic device available for launch; autonomously launching the launch unit from the at least one portable launch assembly based at least upon the real-time authorization signal; and capturing, via the designator interface, an impact information corresponding to a point of impact of the launch unit within the field of view.

In some aspects, the techniques described herein relate to a method, wherein the step of designating the target further includes determining a geolocation of the target.

In some aspects, the techniques described herein relate to a method, wherein the step of transmitting the target signal includes: wirelessly transmitting the target signal from a data source remotely located from the first electronic device, wherein the data source includes a deployable node, an aerial vehicle, an orbital vehicle, an optical instrument, or a combination thereof; transmitting the target signal from the data source via a physical connection, wherein the data source includes an optical instrument; or both.

In some aspects, the techniques described herein relate to a method, wherein the step of ascertaining the second electronic device available for launch includes determining, via the designator interface, a launch parameter, where the launch parameter includes determination of the at least one portable launch assembly, a class of the launch unit, a fuze associated with the launch unit, or a combination thereof.

In some aspects, the techniques described herein relate to a method, wherein determining the launch parameter occurs simultaneous with viewing the target through the designator interface.

In some aspects, the techniques described herein relate to a method, wherein determining the launch parameter further includes selecting the class of the launch unit prior to selecting the fuze associated with the launch unit.

In some aspects, the techniques described herein relate to a method, wherein the first electronic device includes an external mechanical interface; and the steps of designating the target, ascertaining the second electronic device available for launch, and providing the real-time authorization signal are executable via the external mechanical interface.

In some aspects, the techniques described herein relate to a method, wherein: the step of receiving the launcher signal further includes: receiving a signal representative of a geolocation of the second electronic device; and receiving a signal representative of a class of the launch unit and a fuze associated with the launch unit; and the step of ascertaining the second electronic device available for launch further includes determining a targetable range of at least one of the second electronic device based upon the signal representative of the geolocation of the second electronic device and the signal representative of the class of the launch unit.

In some aspects, the techniques described herein relate to a method, wherein the step of designating the target further includes viewing, via the designator interface, the target via direct line of sight; and wherein determining the geolocation of the target is based on a geolocation data associated with the first electronic device and a sensor associated with the first electronic device.

In some aspects, the techniques described herein relate to a method, wherein the step of receiving the launcher signal further includes: determining a targetable range of the at least one portable launch assembly, the launch unit, or a combination thereof; generating an engageable launcher status based on comparing the targetable range of the at least one portable launch assembly, the launch unit, or a combination thereof to the target signal; and modifying the launcher signal with the engageable launcher status.

In some aspects, the techniques described herein relate to a method, wherein the step of receiving the launcher signal is based on a class of the launch unit, a fuze associated with the launch unit, or a combination thereof.

In some aspects, the techniques described herein relate to a method, wherein the step of autonomously launching the launch unit further includes: dynamically determining an airspace deconfliction status associated with the launch unit and an air vehicle.

In some aspects, the techniques described herein relate to a method, wherein the step of capturing the impact information further includes: identifying, via the designator interface, the point of impact of the launch unit, where the step of identifying the point of impact includes determining a geolocation of the point of impact; and comparing the point of impact of the launch unit to the user input designating the target to determine an impact error.

In some aspects, the techniques described herein relate to a method, further including: modifying a second launch signal with the impact error; and transmitting, via the secure network, the second launch signal from the first electronic device to the second electronic device available for launch.

In some aspects, the techniques described herein relate to a method, wherein the designator interface further includes a second designator interface; and the step of ascertaining the second electronic device available for launch occurs distinctly from the designator interface and further includes selection of a class of the launch unit, a fuze associated with the launch unit, or a combination thereof.

In some aspects, the techniques described herein relate to a system for executing a launch of at least one portable launch assembly configured to launch a launch unit, including: a plurality of electronic devices, each of the plurality of electronic devices including a communication unit configured to selectively communicatively couple each of the plurality of electronic devices to one another such that each of the plurality of electronic devices are in association with one another; a first electronic device of the plurality of electronic devices, the first electronic device including a designator interface; a second electronic device of the plurality of electronic devices, the second electronic device being operatively and physically coupled with the at least one portable launch assembly, the second electronic device being communicatively coupled with the first electronic device; a data source of the plurality of electronic devices, the data source including a sensor with a field of view, the data source being communicatively coupled with the first electronic device; and the designator interface further including: a visual display for displaying information; a plurality of graphical icons displayed within the visual display, each of the plurality of graphical icons selectable; wherein, upon selection of a first portion of the plurality of graphical icons, an object within the field of view is designated as a target; wherein, upon selection of a second portion of the plurality of graphical icons, one or more of the at least one portable launch assembly is displayed as an available portable launch assembly; and wherein, upon selection of a third portion of the plurality of graphical icons, the launch unit is designated for launch from the available portable launch assembly; and wherein, upon selection of a fourth portion of the plurality of graphical icons, the first electronic device transmits a real-time authorization signal to the second electronic device to autonomously launch the launch unit.

In some aspects, the techniques described herein relate to a system, wherein the first electronic device includes: an external mechanical interface operatively coupled to the designator interface; and wherein the external mechanical interface is operable to provide the selection of the first, second, third, and fourth portions of the plurality of graphical icons.

In some aspects, the techniques described herein relate to a system, further including: a plurality of selectable fuzes associated with the launch unit; the launch unit further including a plurality of selectable classes of the launch unit; wherein, upon selection of a fifth portion of the plurality of graphical icons, a class of the plurality of selectable classes and a fuze of the plurality of selectable fuzes are associated with the launch unit designated for launch.

In some aspects, the techniques described herein relate to a system, wherein the data source includes: a deployable node, an aerial vehicle, an orbital vehicle, an optical instrument physically coupled to the first electronic device, or a combination thereof . . . .

Unless otherwise defined, all technical and scientific terms used herein have the same meaning as commonly understood by one of ordinary skill in the art to which this invention belongs. Any aspect of the disclosure herein may be embodied in other specific forms without departing from the spirit or essential attributes thereof, and it is therefore desired that aspects of the disclosure be considered in all aspects as illustrative and not restrictive. Any headings utilized in the description are for convenience only and no legal or limiting effect. Numerous objects, features, and advantages of the aspects of the disclosure set forth herein will be readily apparent to those skilled in the art upon reading of the following disclosure when taken in conjunction with the accompanying drawings.

### BRIEF DESCRIPTION OF THE DRAWINGS

Hereinafter, various exemplary aspects of the disclosure are illustrated in more detail with reference to the drawings.

FIG. 1 illustrates an aspect of the method 100 of executing a launch 102 of at least one portable launch assembly 104 configured to launch a launch unit 106.

FIG. 2 illustrates an aspect of the targeting system 116.

FIG. 3 illustrates an aspect of the designator interface 122 that may be described further herein.

FIG. 4 illustrates an exemplary aspect of the first electronic device 114 provided with the designator interface 122 presented as the optical instrument 138.

FIG. 5 illustrates an exemplary aspect of the data source 146 that may be provided as the aerial vehicle 164.

FIG. 6 illustrates an aspect of the designator interface 122 including a second designator interface 210.

FIG. 7 illustrates an aspect of the system 300 for executing the method 100.

### DETAILED DESCRIPTION

Reference will now be made in detail to aspects of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one aspect can be used with another aspect to yield a still further embodiment.

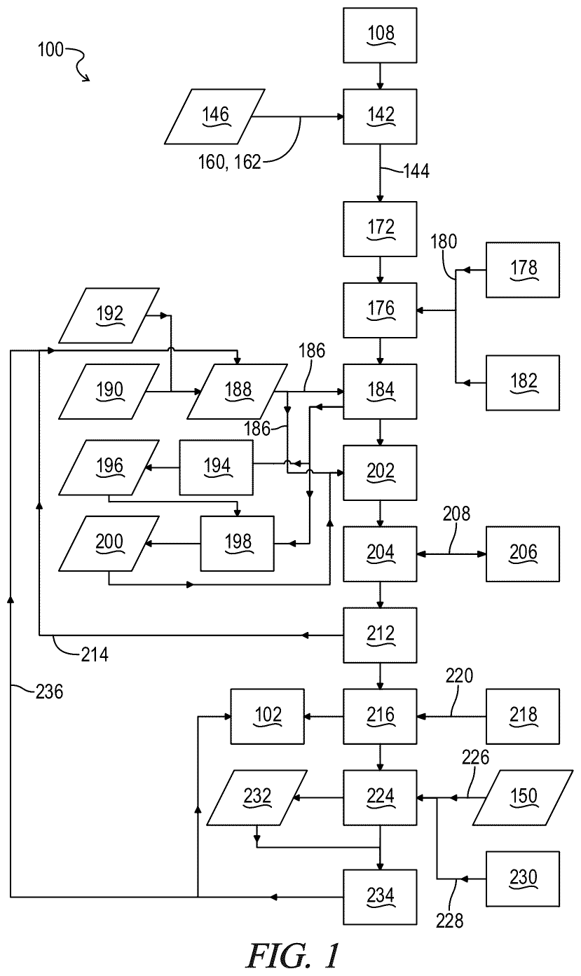

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary aspects only and is not intended as limiting the broader aspects of the present disclosure. Referring generally to FIGS. 1-7, various exemplary aspects may now be described of apparatuses, systems, and methods for executing a launch of at least one portable launch assembly configured to launch a launch unit. Where the various figures describe aspects sharing various common elements and features with other aspects, similar elements and features are given the same reference numerals and redundant description thereof may be omitted below.

FIG. 1 illustrates an aspect of the method 100 of executing a launch 102 of at least one portable launch assembly 104 configured to launch a launch unit 106. An aspect of the method 100 may include a step of selectively forming 108 a secure network 110. The secure network 110 may include a plurality of electronic devices 112.

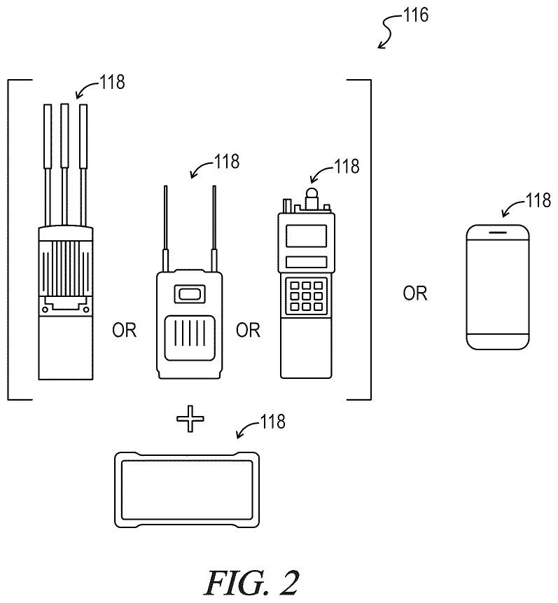

One of the devices of the plurality of electronic devices 112 may be a first electronic device 114. The first electronic device 114 may be associated with a targeting system 116 to be employed in the method 100. FIG. 2 illustrates an aspect of the targeting system 116. The targeting system 116 may include one or more types of a targeting device 118 that may be used in conjunction with each other or may be used alternatively from each other. Various nonlimiting examples of the first electronic device 114, which in some instances may be provided as the targeting device 118, may include a radio, a mobile phone, an android mobile device, a targeting application, a plug-in to be used in the targeting application, or a combination thereof. In some aspects, the targeting device 118 may provide for various functionalities, including display of various resources located at one or more electronic devices of the plurality of electronic devices 112, selection of the details and execution of the launch 102, monitor and information feed of a time to impact of the launch unit 106 after launch 102, and the ability to initiate a launch 102 directly from the targeting device 118. In some aspects, the various resources located at the plurality of electronic devices 112 may be described further below with respect to a second electronic device 188. In some aspects, the functionality of selection of the details and execution of the launch 102 may be characterized within the targeting device 118 as an “add-to-cart” launch 102 function to be described further herein.

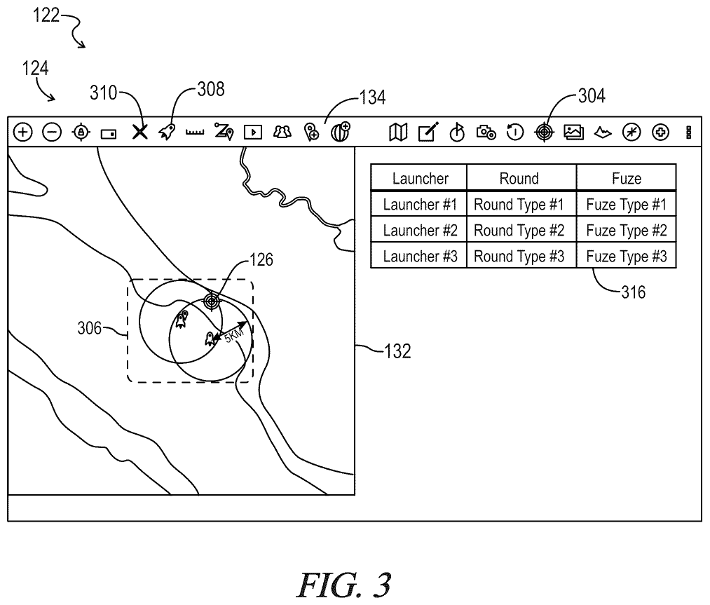

The first electronic device 114 may include a designator interface 122. FIG. 3 illustrates an aspect of the designator interface 122 that may be described further herein. The designator interface 122 may be configured to generate a visual display 124 of a target 126 to a user 128 and receive a user input 130 designating the target 126. Thus, the designator interface 122 may be configured to generate an interactive visual display 124 capable of receiving user input 130. In some aspects, the designator interface 122 may provide information to the user 128 associated with the at least one portable launch assembly 104, the launch unit 106, any number of devices of the plurality of electronic devices 112, or a combination thereof to be described further herein.

In some aspects, the designator interface 122 may be presented as a graphical user interface 132 or a similar type of user interface that allows the user 128 to interact with the first electronic device 114 through graphical icons 134. The graphical user interface 132 is not limited to graphical icons 134, and, in some aspects, may further include informational text-based interfaces, typed command labels, text navigation, or visual indicators. Various functionalities of the designator interface 122 and as associated with the graphical icons 134 will be described further herein. Additional graphical icons 134 may be employed within the graphical user interface 132 to provide additional functions, including those associated with the steps of the method 100, including steps such as designating 176 the target 126, determining 194 the targetable range 196 if the at least one portable launch assembly 104 and/or the launch unit 106, ascertaining 204 the second electronic device 188 available for launch, determining 206 the launch parameter 208, and providing 212 the real-time authorization signal 214.

The graphical icons 134 may provide functions associated with the designator interface 122 and the visual display 124, including exemplary icons such as the following: (1) Layer Icon (Stack of Sheets): This icon typically represents layers or overlays, allowing users to manage different layers of information on the map such as weather, terrain, operational data, etc.; (2) Eye Icon: This icon is generally used for settings related to visibility or displaying additional details on the map, possibly allowing users to toggle the visibility of certain elements on the screen; (3) Target Icon: Usually, this icon is associated with targeting or marking specific locations or objectives on the map; (4) Pen Icon: This likely represents tools for drawing or marking the map, which can include lines, areas, or specific points; (5) Arrow or Direction Icon: This could represent navigation or direction-related functionalities, potentially allowing users to set routes or get directions; (6) Satellite Dish Icon: Typically, this icon is used to indicate communication features or settings, possibly related to data transmission, connectivity status, or communication tools within the application; (7) Crosshair Icon: Often used for precision location or focusing on a specific point on the map, this could be related to zooming in on a particular area or aligning the map to a precise point; (8) Magnifying Glass Icon: Universally recognized as a search tool, it can be used to search for specific locations, coordinates, or items within the map database; (9) Circles with Center Point Icon: This icon might be related to location services, such as displaying your current location or the location of other team members; (10) Wrench Icon: Typically represents settings or tools, this could be where users access system settings, configuration options, or tool adjustments; (11) Star Icon: Often used for bookmarking or highlighting favorite or important locations, routes, or points of interest on the map; (12) Question Mark Icon: Generally used for help or information, users can access user manuals, FAQs, or support for using the application.

In some aspects, the visual display 124 may be operatively associated with a third-party software, including Android Tactical Assault Kit (ATAK), Joint Effects Targeting System (JETS), Rapid Targeting and Ranging Module-S(RAPTAR-S), Special Operations Forces Laser Acquisition Marker (AN/PEQ-1C SOFLAM).

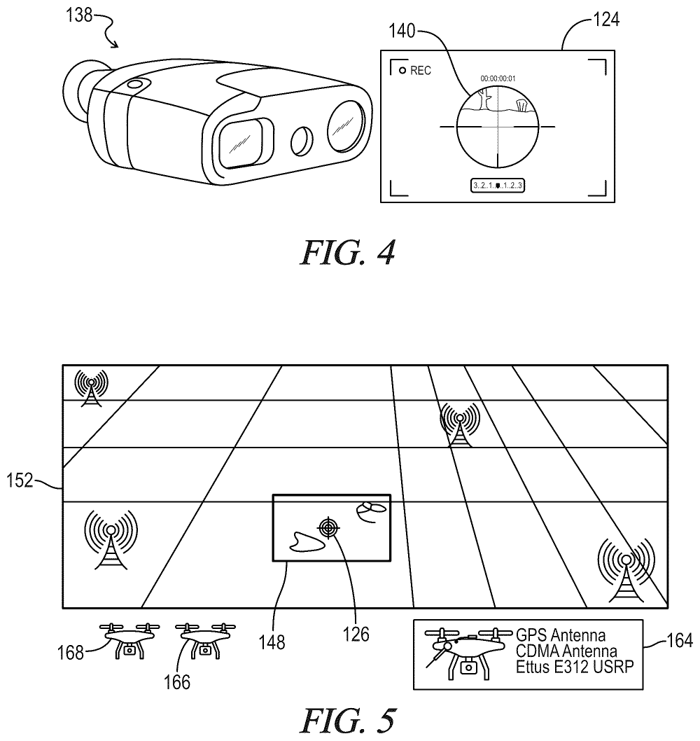

In some aspects, the designator interface 122 may be presented as an optical instrument 138. In some aspects, the optical instrument 138 may include optical components and system to identify, target, and guidance the launch unit 106. The optical instrument 138 may include components known by those of skill in the art to provide functions to focus and magnify an image of the target 126, including various lenses. FIG. 4 illustrates an exemplary aspect of the first electronic device 114 provided with the designator interface 122 presented as the optical instrument 138. The visual display 124 may include a reticle 140 provided as a crosshair or aiming point within the visual display 124 and may be a simple cross, dot, or more complex patterns like Mil-Dot, which may assist in range estimation and windage adjustments. Advanced reticle 140 may also incorporate illumination for better visibility under low-light conditions.

In some aspects, the first electronic device 114 may include light emitters, such as laser emitters, to generate a laser beam for designation of the target 126. The first electronic device 114 may also include sensors, including cameras or photodetectors, to capture images or measure reflected laser light, and convert optical signals into electronic data for further processing. The first electronic device 114 may also include mirrors, prisms, or equivalent structures operable to direct and manipulate a light path within the designator, direct the laser beam accurately onto the target 126, and fold the optical path in compact designs. The first electronic device 114 may further include various filters to selectively allow light to pass through the filter and to enhance image clarity and reduce glare or interference. The first electronic device 114 may include adjustment turrets for windage and elevation adjustments and allow the user 128 to determine trajectory adjustments needed to compensate for various environmental factors. The first electronic device 114 may include magnification adjustments, parallax adjustments, objective lenses, eye relief, zero stop, and other features known to those of skill in the art.

In some aspects, the first electronic device 114 may be operably linked to the designator interface 122. In some exemplary aspects, the first electronic device 114 may be provided as one device within the targeting system 116 and may require an additional device of the plurality of electronic devices 112 to provide the designator interface 122. In an exemplary aspect, the first electronic device 114 may include a radio, mobile phone, satellite phone, or other communication device that may be operative linked to a handheld device, where the handheld device is operable by the user 128 and includes the designator interface 122. In some aspects, the device including the designator interface 122 may be provided as a tablet, computer, or other computer device capable of providing the designator interface 122 and the visual display 124.

The method 100 may also include a step of transmitting 142 a target signal 144 from a data source 146 of the plurality of electronic devices 112 to the first electronic device 114. The transmitting 142 may occur via the secure network 110. The data source 146 may be associated with a field-of-view 148 that represents the area visible by the data source 146.

The data source 146 may include a sensor 150 operable to gather information from a potential area 152 surrounding the data source 146 and provide such information in a visual format to the user 128. In some aspects, the sensor 150 may be operable to gather information via the following: (1) Charge-Coupled Device (CCD) Sensors: These sensors are highly sensitive and convert light into electrical signals, producing high-quality images with low noise; ideal for applications in photography, astronomy, and scientific imaging; (2) Complementary Metal-Oxide-Semiconductor (CMOS) Sensors: Similar to CCD sensors in function, CMOS sensors are more cost-effective, consume less power, and are widely used in consumer electronics such as smartphones and digital cameras; (3) Infrared Sensors: Specializing in detecting infrared radiation, these sensors are essential for applications requiring imaging beyond the visible spectrum, such as night vision and thermal imaging devices; (4) Ultraviolet Sensors: These sensors detect ultraviolet light and are crucial in fields like astronomy and forensic science, helping to analyze substances and detect sun damage; (5) LIDAR (Light Detection and Ranging) Sensors: Utilizing laser light to create detailed maps of the physical world, LIDAR sensors are fundamental in autonomous vehicle technology and geographical mapping; (6) Photodiodes: Designed to convert light into electrical current, photodiodes are used in various devices including light meters and safety equipment; (7) Time of Flight (ToF) Cameras: These cameras measure the travel time of light to create depth maps, aiding in 3D imaging for augmented reality and robotics; (8) Multispectral and Hyperspectral Sensors: These sensors capture data across multiple wavelengths, indispensable in satellite imaging and agricultural applications to analyze crop health and environmental conditions; (9) Thermal Imaging Cameras: Detecting heat emitted by objects, thermal cameras are used in firefighting, security, and building inspection to identify heat leaks and see through smoke; (10) Color Sensors: Capable of detecting and differentiating colors, these sensors are employed in industrial sorting processes and quality control, ensuring consistency and accuracy in manufacturing. Each sensor type may be tailored to specific technological needs and environmental conditions.

In some aspects, the sensor 150 may be capable of providing information associated with the situational awareness of the plurality of electronic devices 112 to which they are associated, including the following: (1) Global Positioning System (GPS) Sensors, which provide precise geolocation data (latitude, longitude, and altitude); (2) Inertial Measurement Units (IMUs), which measure the object's orientation, angular velocity, and linear acceleration; (3) Magnetometers, which measure the strength and direction of magnetic fields to determine the object's heading; (4) Laser Rangefinders, which measure the distance to a target by timing the reflection of a laser beam; (5) Radar Sensors, which use radio waves to detect the range, angle, and velocity of objects; (6) LiDAR (Light Detection and Ranging) Sensors, which use laser light to measure distances and create detailed 3D maps of the environment; (7) Electro-Optical (EO) Sensors, which capture visual and infrared images; (8) Acoustic Sensors, which detect sound waves and measure their characteristics; (9) Thermal Imaging Sensors, which detect infrared radiation and produce thermal images; (10) Proximity Sensors, which detect the presence and distance of nearby objects; (11) Gyroscopes, which measure the rate of rotation around an axis. The sensor 150 may be associated with any of the plurality of electronic devices 112, including the first electronic device 114 and the second electronic device 188.

In some aspects, the target signal 144 may provide information corresponding to the field-of-view 148 as captured by the sensor 150. In some aspects, the target signal 144 may provide information corresponding to the particular sensor 150 of the data source 146. In some aspects, the target signal 144 may provide information corresponding to the target 126 within the field-of-view 148 of the data source 146. The data source 146 may be provided as a variety of structures and may be deployed within the potential area 152 within visual range of the target 126. In some aspects, the target signal 144 may be provided to the first electronic device 114 by action of wireless transmitting 160 the target signal 144 from the data source 146. The action of wireless transmitting 160 may be from a data source 146 that is remotely located from the first electronic device 114, including a plurality of the data source 146 remotely located from each other and from the first electronic device 114. In some aspects, the target signal 144 may be provided to the first electronic device 114 by action of wired transmission 162 of the target signal 144 from the data source 146. The action of wired transmission 162 may include generally information transmission via a physical connection as opposed to a wireless or over-the-air connection, with the wired transmission 162 including a wired connection.

In some aspects, the data source 146 may be provided as a deployable node 154. In some aspects, the data source 146 may be provided as any number of more than one of the deployable node 154. The deployable node 154 may be a stationary mount 156 including the sensor 150. The sensor 150 may be operable to rotate or elevate the field-of-view 148. The operable nature of the sensor 150 to alter the field-of-view 148 may be operated by the user 128, automatic, autonomous, or any combination thereof. The deployable node 154, as one of the plurality of electronic devices 112, may be communicatively coupled to a number of other of the deployable node 154 and may operatively share and associate information from the sensor 150 of each of the deployable node 154 in a coordinated manner. In some aspects, the deployable node 154 may be provided as a mobile vehicle 158 including the sensor 150. The mobile vehicle 158 may be automated, controlled by a user 128, autonomous, or a combination thereof. The mobile vehicle 158 may also be able to traverse multiple environments, including land, air, and water.

In some aspects the, the data source 146 may be provided as an aerial vehicle 164. FIG. 5 illustrates an exemplary aspect of the data source 146 that may be provided as the aerial vehicle 164. The aerial vehicle 164 may be provided as an unmanned aerial vehicle (UAV) or as a manned aerial vehicle. In some exemplary aspects, the data source 146 may include a plurality of the aerial vehicle 164. The plurality of the aerial vehicle 164 may be communicatively and operatively coupled to each other. A first aerial vehicle 166 may operate as a mapper to gather information of the potential area 152, gather information corresponding to a plurality of the field-of-view 148 surrounding the target 126, or other areas of interest. In some aspect, the first aerial vehicle 166 may operate through an undefined path. Another aerial vehicle 168 may operate as a navigator. The other aerial vehicle 168 may operate upon a predefined or closed-loop path to provide iterative and continuous information concerning a scope of the potential area 152, the field-of-view 148 surrounding the target 126, or other areas of interest.

In some aspects, the data source 146 may be provided as an orbital vehicle 170. The orbital vehicle 170 may be provided in a geostationary holding pattern, maintaining a constant scope of the field-of-view 148 of the potential area 152 around the target 126. The orbital vehicle 170 may also be provided in an orbital movement pattern, gathering iterative images of the field-of-view 148 over a determinable swath width. The orbital vehicle 170 may be provided with various types of the sensor 150 as known to capture definable information.

In some aspects, the data source 146 may be provided as the optical instrument 138. Where the data source 146 is provided as the optical instrument 138, the optical instrument 138 may include structures and components as described above.

The method 100 may include a step of displaying 172 the field-of-view 148 associated with the target signal 144. The step of displaying 172 may be an action associated with the designator interface 122, the visual display 124, the data source 146, or any one or more of the plurality of electronic devices 112. In some exemplary aspects, the user 128 may view the field-of-view 148 by the designator interface 122 and/or the visual display 124 associated with the designator interface 122. By action associated with the designator interface 122, the user 128 may manipulate the visual display 124 and the field-of-view 148 displayed according to preferences and actions desired by the user 128. In an exemplary aspect, the user 128 may manipulate the visual display 124 of the field-of-view 148 by panning, zooming, rotating, including three-dimensional rotation, overlaying various data, annotating, altering display modes, applying filters, altering for real-time updates, performing simulation and predicting estimation, interacting with additional systems, and combinations thereof.

In exemplary aspects, overlaying various data may include overlaying geolocation data, range indicators of the at least one portable launch assembly 104, geolocation data of the plurality of electronic devices 112, and other overlays as the user 128 may determine information pertinent for the launch 102. In exemplary aspects, annotating the field-of-view 148 may include indicating points of interests, including flagging particular locations for action or nonaction, potential targets, or other areas of concern. Annotating may also include indicating potential trajectories for the launch 102 and potential flight paths or information concerning other vehicles that may be presenting, or in the future, occupying airspace over the potential area 152 around the target 126, the user 128, the first electronic device 114, the data source 146, the plurality of electronic devices 112, or any combination thereof. In exemplary aspects, performing simulation and predicting estimation may include simulating a flight path of the launch unit 106 to the target 126 and may generate a predicted point-of-impact considering environmental and temporal parameters. Simulation and prediction may also include estimating potential secondary effects of the predicted point-of-impact on the potential area 152 surrounding the target 126, the user 128, the first electronic device 114, the data source 146, the plurality of electronic devices 112, or any combination thereof.

The method 100 may also include a step of designating 176 the target 126 within the field-of-view 148. In some aspects, the step of designating 176 may be performed by action associated with the designator interface 122. The step of designating 176 the target 126 may include designating multiple of the target 126. The step of designating 176 may also include assigning a level associated with each target 126, the level associated being capable of indicating a level of importance, a sequence associated with multiple of the target 126, a risk associated with a launch 102 for each target 126, or other parameters desired to be attributed to each target 126.

In some aspects, the step of designating 176 the target 126 may include determining 178 a geolocation 180 of the target 126. Determining 178 the geolocation 180 of the target 126 may include evaluation of information associated with the plurality of electronic devices 112, the first electronic device 114, the target signal 144, the target 126, or a combination thereof. In an exemplary aspect, the geolocation 180 may be determined by action of the sensor 150 associated with the data source 146. The target signal 144 may also indicate a geolocation 180 of the data source 146 and the target 126 within the field-of-view 148 of the 146. A sensor 150 associated with the first electronic device 114 may indicate the geolocation 180 of the first electronic device 114. In some exemplary aspects, the first electronic device 114 as communicatively coupled to the plurality of electronic devices 112 and the data source 146 may determine the geolocation 180 of the target 126 based upon a coordinate consideration of the geolocation 180 of a plurality of the plurality of electronic devices 112, first electronic device 114, the data source 146, or the target signal 144.

In some aspects, the step of designating 176 the target 126 may include viewing 182 the target 126 from the first electronic device 114 by direct line of sight. The user 128 may view the target 126 located within the field-of-view 148 of the data source 146 through the visual display 124 of the designator interface 122. The first electronic device 114 may include the data source 146 and/or may include the optical instrument 138 to view the target 126 directly from the first electronic device 114. The first electronic device 114 may also include the sensor 150 associated with the first electronic device 114 to aid in the determining 178 of the geolocation 180 of the target 126. The sensor 150 associated with the first electronic device 114 may provide information relating to the relationship between the situational awareness of the first electronic device 114 and the target 126. In an exemplary aspect, the sensor 150 associated with the first electronic device 114 may provide information associated with the first electronic device 114, including azimuth, heading, geolocation, and other situational awareness data associated with the first electronic device 114. The information from the sensor 150 associated with the first electronic device 114 and the geolocation 180 of the first electronic device 114 and the step of designating 176 the target 126 may together provide the geolocation 180 of the target 126.

The method 100 may also include a step of receiving 184 a launcher signal 186 representative of at least one of a second electronic device 188 of the plurality of electronic devices 112. The second electronic device 188 may be associated with the at least one portable launch assembly 104, the launch unit 106, or a combination thereof. The first electronic device 114 may receive the launcher signal 186 via the secure network 110 from one or more of the plurality of electronic devices 112. In some aspects, the second electronic device 188 may generate and provide the launcher signal 186 based upon some parameter associated with the launch 102 to be discussed further herein. The launcher signal 186 may indicate information associated with the at least one portable launch assembly 104, the launch unit 106, or both. In an exemplary aspect, the launcher signal 186 may provide information associated with the geolocation 180 of each of the at least one portable launch assembly 104 and the launch unit 106, may provide information associated with a particular operational characteristics associated with each of the at least one portable launch assembly 104 and the launch unit 106, including a class 190 of the launch unit 106, a fuze 192 associated with the launch unit 106, or a combination thereof.

In some aspects, the step of receiving 184 the launcher signal 186 may include a step of determining 194 a targetable range 196 of the at least one portable launch assembly 104, the launch unit 106, or a combination thereof. The targetable range 196 of the at least one portable launch assembly 104 may be determinable in part based upon a particular class of the at least one portable launch assembly 104, a situational awareness of the at least one portable launch assembly 104, temporal awareness of the plurality of electronic devices 112 and the target 126. In exemplary aspects, the targetable range 196 of the at least one portable launch assembly 104 and/or the launch unit 106 may be determinable based on at least one or more of the following: (1) Munition Type and Design, which includes the specific design, weight, and aerodynamic properties of the munition itself; (2) Launcher Type and Configuration, which refers to the different types of launchers (e.g., artillery, rocket, missile) and their configurations, such as barrel length and launch angle; (3) Propellant Characteristics, which involve the type, quality, and amount of propellant used in the munition; (4) Launch Angle, which affects the trajectory and range of the munition; (5) Environmental Conditions, including weather conditions such as wind, temperature, humidity, and atmospheric pressure; (6) Elevation and Terrain, which encompasses the altitude of the launch site and the terrain between the launcher and the target; (7) Target Movement, which requires adjustments in range and time of flight to ensure accurate targeting; (8) Launcher Mobility and Stability, referring to the mobility and stability of the launcher platform; (9) Guidance Systems, which can enhance range by providing mid-course corrections and optimizing the flight path; (10) Fuel Efficiency and Weight, involving the efficiency of the fuel and the overall weight of the munition; (11) Electronic and Sensor Systems, which provide real-time data and adjustments to improve range by optimizing flight dynamics and compensating for environmental factors.

In some aspects, the step of receiving 184 the launcher signal 186 may include generating 198 an engageable launcher status 200 based on comparing the targetable range 196 of the at least one portable launch assembly 104, the launch unit 106, or both to the target signal 144. The engageable launcher status 200 may indicate all or less than all of the at least one portable launch assembly 104 and/or the launch unit 106 that have a targetable range 196 that may presently or in the future encompass and overlap with the target 126 as ascertainable from the target signal 144. An aspect of generating 198 the engageable launcher status 200 may include considering in part the particular class of the at least one portable launch assembly 104, the situational awareness of the at least one portable launch assembly 104, the temporal awareness of the plurality of electronic devices 112 and the target 126 as described above, including exemplary aspects thereof.

In some aspects, the step of receiving 184 the launcher signal 186 may include a step of modifying 202 the launcher signal 186 with the engageable launcher status 200. The step of modifying 202 the launcher signal 186 based upon the engageable launcher status 200 may include indicating a preference associated with one or more of the at least one portable launch assembly 104 and/or the launch unit 106, including various classes thereof.

In some aspects, the step of receiving 184 the launcher signal 186 is based at least on the class of the launch unit 106, the fuze 192 associated with the launch unit 106, or a combination thereof. The first electronic device 114 may receive the launcher signal 186 that indicates only those of the at least one portable launch assembly 104 equipped with certain of the launch unit 106 desired for any particular launch 102. In an exemplary aspect, the user 128 may indicate a particular one or more of a type of the at least one portable launch assembly 104 or the launch unit 106 for any particular launch 102, the launch 102 may be tailored to the target 126, the potential area 152 surrounding the target 126, or the positional relationship between the first electronic device 114 and the target 126.

In some exemplary aspects, the launch unit 106 may be provided as selectable or available rounds, including high explosive (HE), frag, and smokescreen, or various combinations thereof. Other types of rounds may be known to those of skill in the art and may be selectable based upon the desired parameters of any specific launch 102 and/or target 126. In some exemplary aspects, the launch unit 106 may be provided as an armor-piercing (AP) round, an incendiary round, an illumination round, and anti-tank guided missile (ATGM) round, thermobaric round, chemical round, training round, high-explosive anti-tank (HEAT) round, or cluster round.

In some aspects, the step of receiving 184 the launcher signal 186 may be based upon the fuze 192 associated with the launch unit 106. In some exemplary aspects, various types of the fuze 192 may be selectable or available, including impact (IMP) fuzes, proximity (PRX) fuzes, delay (DEL) fuzes, point-detonating (PD) fuzes, proximity (VT) fuzes, delay type fuzes, or timed fuzes. In some aspects, the fuze 192 may be selectable independent of each of the launch unit 106.

The method 100 may also include a step of ascertaining 204 the second electronic device 188 available for launch. In some aspects, the step of ascertaining 204 may occur by action associated with the designator interface 122. The step of ascertaining 204 the second electronic device 188 available for launch may evaluate the which of the at least one portable launch assembly 104 are within the targetable range 196 of the target 126 based upon launch parameters, including known environmental conditions, temporal mobility of the location of the at least one portable launch assembly 104 and/or the target 126, or other various launch parameters described herein.

In some aspects, the step of ascertaining 204 may at least be based on the target signal 144 and the launcher signal 186. In exemplary aspects, ascertaining 204 the second electronic device 188 available for launch may include considering the geolocation of the target 126 and the second electronic device 188 in the present or in the future and parameters of the launch 102 as described herein, including specific types of the at least one portable launch assembly 104, the launch unit 106, or the fuze 192 associated with the launch unit 106.

In some aspects, the step of ascertaining 204 the second electronic device 188 available for launch may include a step of determining 206 a launch parameter 208. The step of determining 206 the launch parameter 208 may be performed by action associated with the designator interface 122 or the user 128 engaging with the designator interface 122. In exemplary aspects, the launch parameter 208 may include a determination of the at least one portable launch assembly 104, the launch unit 106, a class associated with the at least one portable launch assembly 104 and/or the launch unit 106, a fuze 192 associated with the launch unit 106, or a combination thereof. The launch parameter 208 may allow a user 128 to view the at least one portable launch assembly 104, the geolocation 180 associated with the at least one portable launch assembly 104, the targetable range 196 corresponding associated with each of the at least one portable launch assembly 104, and any particular class associated with the at least one portable launch assembly 104. In an exemplary aspect, the user 128 may use the designator interface 122 to view a number of the at least one portable launch assembly 104, where one of the at least one portable launch assembly 104 may be a portable and stationary or a portable and mobile launch assembly. The designator interface 122 may also provide the targetable range 196 of each of the at least one portable launch assembly 104 and show how each targetable range 196 intersects with the target 126 or potential future areas of the target 126. Further, the designator interface 122 may provide information to the user 128 regarding the available rounds for the launch unit 106 associated with the at least one portable launch assembly 104 and the fuze 192 associated with the launch unit 106.

The step of determining 206 the launch parameter 208 may occur simultaneous with a step of viewing 182 the target 126 through the designator interface 122. In some aspects, the designator interface 122 and the visual display 124 may provide the functionality to view and determine the launch parameter 208 associated with the launch 102 in the same visual display 124 as viewing 182 the target 126. As shown in FIG. 3, the designator interface 122 may provide functionality to view the target 126 and the available launchers along with their targetable ranges and may additionally provide various of the at least one portable launch assembly 104 along with available rounds and fuzes available to launch from each of the at least one portable launch assembly 104.

In some aspects, the step of determining 206 the launch parameter 208 may include selecting the class 190 of the launch unit 106 prior to selecting the fuze 192 associated with the launch unit 106. In an exemplary aspect, the user 128 may view any one of the at least one portable launch assembly 104 and the rounds of the launch unit 106 available at that one of the at least one portable launch assembly 104. The user 128 may then select one round of the launch unit 106, a fragmentation round for example, and then may customize the fuze 192 to be associated with that launch unit 106, such as a delay (DEL) fuze.

In some aspects of the method 100, the step of receiving 184 the launcher signal 186 may include receiving a signal representative of the geolocation 180 of the second electronic device 188, receiving a signal representative of the class 190 of the launch unit 106, and receiving a signal representative of the fuze 192 associated with the launch unit 106. In some aspects, the signal representative of the class 190 of the launch unit 106 may include the fuze 192 associated with the launch unit 106.

The step of ascertaining 204 the second electronic device 188 available for launch may include determining the targetable range 196 at least one of the second electronic device 188 based upon the signal representative of the geolocation 180 of the second electronic device 188 and the signal representative of the class 190 of the launch unit 106. In some aspects, determining the targetable range 196 of the second electronic device 188 may also be based upon the particular at least one portable launch assembly 104. The signal representative of the class 190 of the launch unit 106, the at least one portable launch assembly 104, and/or the fuze 192 may provide an indication of the physical limitations associated with each of the launch unit 106 and the at least one portable launch assembly 104 contemplated for use in the launch 102. The at least one portable launch assembly 104 may have a known range of trajectories, a known maximum launching force associated with the at least one portable launch assembly 104, and other known or determinable characteristics that indicate a maximum targetable range 196 and maximum characteristics of the trajectory or flight path of the launch unit 106. Similar known or determinable characteristics may be associated with the launch unit 106 and/or the fuze 192.

Signals associated with the geolocation 180 of the second electronic device 188 may indicate environmental conditions, including weather conditions and elevation and terrain, which may influence the targetable range 196 and the maximum trajectory associated with the launch unit 106 after a launch 102.

In some aspects, the method 100 may include determining the future position areas associated with the at least one portable launch assembly 104 and/or the launch unit 106 according to geolocation 180, environmental conditions, and information pertaining to the class 190 associated with each of the at least one portable launch assembly 104 and the launch unit 106. The future position areas may indicate all possible future volumes that may be occupied by the launch unit 106 after the launch 102.

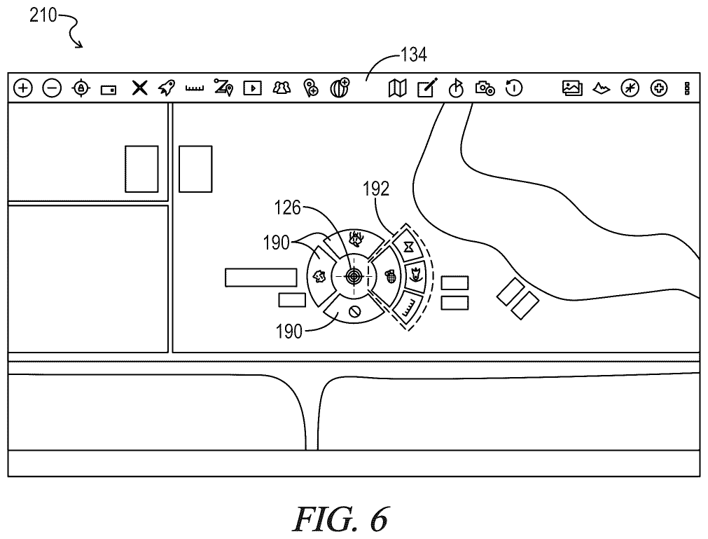

FIG. 6 illustrates an aspect of the designator interface 122 including a second designator interface 210. The step of ascertaining 204 the second electronic device 188 available for launch may occur in the second designator interface 210 distinct from the designator interface 122 and may include selecting the class 190 of the launch unit 106, the fuze 192 associated with the launch unit 106, or a combination thereof. The second designator interface 210 may be characterized as a targeting interface that may provide a visual display 124 different than the visual display 124 present in the designator interface 122, including a graphical user interface 132 and graphical icons 134 different from those presented in the visual display 124 of the designator interface 122. In an exemplary aspect, the second designator interface 210 targeting interface may provide a targeting menu that allows the user 128 to select various parameters associated with the at least one portable launch assembly 104, launch unit 106, and fuze 192 while viewing the target 126. In some aspects, the second designator interface 210 may be characterized as a sub-menu or different graphical user interface 132 than information associated with the designator interface 122. In some aspects, performing steps by action associated with the designator interface 122 may include performing the same steps by action associated with the second designator interface 210.

The method 100 may include a step of providing 212 a real-time authorization signal 214 to the second electronic device 188 available for launch. The step of providing 212 the real-time authorization signal 214 may occur by action associated with the designator interface 122 and by the secure network 110. The user 128 who has determined the at least one portable launch assembly 104, the launch unit 106, and the fuze 192 associated with the launch unit 106 may authorize for launch 102 all by real-time action associated with the designator interface 122. In an exemplary aspect, the user 128 may designate the target 126, select which of the at least one portable launch assembly 104 is within the targetable range 196 of the target, confirm the at least one portable launch assembly 104 may provide the desired launch unit 106 and fuze 192, and authorize the system for launch.

The method 100 may include a step of autonomously launching 216 the launch unit 106 from the at least one portable launch assembly 104 based on the real-time authorization signal 214. The autonomous aspect of the step of launching 216 the launch unit 106 may include the capability of the system for launch to perform tasks or make decision independently, without user 128 intervention, by perceiving the environment disclosed herein, analyzing data disclosed herein, and adapted to changing environments and data. In exemplary aspects, the autonomous aspect of the step of launching 216 may include recognizing an inability of the at least one portable launch assembly 104 to launch the launch unit 106 and launching 216 from a different one of the at least one portable launch assembly 104. Other examples include relaunching upon confirmation the target 126 is still designated, avoiding launch if there is risk of the launch unit 106 intersecting an air vehicle or any of the plurality of electronic devices 112 associated with a friendly or off-limit entity, and other situations that may benefit from autonomous launching 216 as determinable by the user 128 for any particular launch 102.

The step of autonomously launching 216 the launch unit 106 may include dynamically determining 218 an airspace deconfliction status 220 associated with the launch unit 106 and an air vehicle 222. The method 100 may include receiving, at any one of the plurality of electronic devices 112, a signal associated with an air vehicle 222 that is presently or may in the future be in an area around the launch 102. The method 100 may determine a set of future position areas associated with the air vehicle 222 and with the launch unit 106 to be launched from the at least one portable launch assembly 104 and may dynamically determine whether those future position areas with intersect at any predefined time period extending from the present to a future time. In some aspects, the step of autonomous launching 216 may prevent the launch 102 of the launch unit 106 until there is no potential intersection of the future position areas of the launch unit 106 and the air vehicle 222, thus indicating an airspace deconfliction status 220.

In some aspects, the step of dynamically determining 218 the airspace deconfliction status 220 may incorporate a data flow operation that operates in an on/off result configuration, designating the launch 102 of the launch unit 106 only when the launch state toggles to an ON position. Otherwise, if the data flow operation cannot determine a valid airspace deconfliction status 220, the data flow operation remains in an OFF state and does not provide authorization for the launch 102. In an exemplary embodiment of the data flow operation, upon initiation, the method 100 may provide for the creation of launcher objects via system data. This system data may include signals representative of situational awareness and class information of the at least one portable launch assembly 104, including position location information (PLI), namely geocoordinate latitude, longitude, and altitude.

The data flow operation may further operate to initiate an event loop. The event loop may further operate to accept information associated with all air vehicles 222 within range of the plurality of electronic devices 112, including those electronic devices 112 that may be included within the secure network 110 associated with the at least one portable launch assembly 104, the launch unit 106, the user 128, and/or observers in the potential area 152.

The data flow operation may continue to create air vehicle objects, with each air vehicle object associated with signals representative of situational awareness of each air vehicle 222, including position location information (PLI), position vector information (PVI), and air vehicle class information. In exemplary embodiments, the method 100 may create an air vehicle object with position information, including geocoordinate latitude, longitude, altitude, and speed.

The data flow operation may continue with a process of detecting possible interactions between the air vehicle objects and the launcher objects. The process of detecting interactions operates to detect possible points of intersection between an air vehicle future position area and a launcher object future position area. For purposes of the present disclosure, reference to the launcher object future position area refers to a future position area determinable for any number of the at least one portable launch assembly 104 and/or the launch unit 106.

The data flow operation may continue with repeating the event loop in the event that any potential interactions are detected between the air vehicle future position area and the launcher object future position area, in which case, the launcher state will remain in an OFF position. The event loop for detecting interactions between the air vehicle future position area and the launcher object future position area may repeat once every second or may be manually configured to repeat at any desired time interval. Alternatively, the data flow operation may continue with authorizing the at least one portable launch assembly 104 for launch 102 based on at least the lack of any interaction between the air vehicle future position area and the launcher object future position area, in which case, the launcher state will toggle to an ON position.

For purposes of the present disclosure, reference to any air vehicle or launcher object future position area refers to a volume of space that may be presently or in the future physically occupied by the at least one portable launch assembly 104, the launch unit 106, and/or the air vehicle 222, and is further used to detect whether an intersection may occur among any two or more of the determinable future position areas. In some aspects, the future time used for determination of a future position area may be established as a maximum future time for consideration (tₘₐₓ) of the launch 102 of the launch unit 106.

The future position areas may represent time-dependent hazard areas, representing the physical limits of where the launch unit 106 and/or the air vehicle 222 may be physically located for a given maximum future time for consideration (tₘₐₓ). The future position areas are determinable to account for all potential positions of the launch unit 106 and/or the air vehicle 222 according to the physical limitations attributable to each of the launch unit and/or air vehicle. Accordingly, future position areas include determination of position uncertainties and latencies associated with the launch unit 106 and/or the air vehicle 222 such that the size of the future position areas are expanded to account for possible errors in a reported position and time since the position was last updated. Further, the future position areas may be approximated as cylindrical volumes defined generally by a radius, a floor, and a ceiling respectively, the distance from a surface of the earth ellipsoid to the bottom or the top of the future position area cylinder.

The future position area of the launch unit 106 may be determinable according to all plurality of potential launch unit flight paths of the launch unit 106. In an illustrative embodiment, the launch unit 106 may be disposed at an origin of a cartesian coordinate system, with the X-axis of the coordinate system corresponding to a horizontal distance capable of being traveled by the launch unit 106 and the Y-axis of the coordinate system corresponding to a vertical distance capable of being traveled by the launch unit 106. In the illustrative embodiment of the future position area of the launch unit 106, the maximum future time for consideration (tₘₐₓ) may be a future time of consideration in which a future position area may be occupied by the launch unit 106, with tₘₐₓ being 20 seconds in one example.

The future position area of the launch unit 106 may be further determinable according to class information of the at least one portable launch assembly 104 and/or launch unit 106. In an exemplary embodiment, the class information of the at least one portable launch assembly 104 and/or launch unit 106 may include a maximum delta-v (ΔV) and a maximum flight path. A maximum delta-v (ΔV) may be a measure of the impulse per unit of launch unit 106 mass that is needed to perform a maneuver such as launching from a ground surface at a known geocoordinate position. A maximum flight path may be associated with an optimal glide ratio of a given launch unit 106.

The future position area of the launch unit 106 may be further determinable by superimposing a plurality of potential launch unit flight paths. The plurality of potential launch unit flight paths may be determinable based on consideration of at least one potential malfunction status associated with the launch 102 of the launch unit 106. In an exemplary embodiment, the malfunction status associated with the launch 102 of the launch unit 106 may include a failure of the guidance system, a failure of a wing or fin deployment, a failure of a launch, or any condition which may prevent the launch unit 106 from attaining a maximum flight path or an optimal glide ratio. Consideration of at least one potential malfunction status associated with the launch 102 of the launch unit 106 may be represented by one or more of the plurality of potential launch unit flight paths which either do not reach a maximum altitude or a maximum downrange distance.

The plurality of potential launch unit flight paths may have a number of different maximum launch altitudes (or ceilings) and a number of different downrange distances (or radii) representing the plurality of possible flight paths based upon consideration of the at least one potential malfunction status associated with the launch 102 of the launch unit 106. Where the at least one portable launch assembly 104 is located on a ground surface, the floor of the future position area of the launch unit 106 may be the ground surface. Accordingly, the plurality of potential launch unit flight paths may be superimposed to determine the future position area of the launch unit 106.

The future position area of the air vehicle 222 may be determinable according to all potential aerospace maneuvers a given air vehicle 222 may perform. The future position area of the air vehicle 222 as represented by a cylindrical volume may be defined by a ceiling, a floor, and a radius. The future position area of the air vehicle 222 may therefore be evaluated for two-dimensional maneuvers of the air vehicle 222 in addition to altitude changes. For any particular maximum future time for consideration (tₘₐₓ), it may be possible for the air vehicle 222 to occupy any two-dimensional location with a radius of the current position of the air vehicle 222 as defined by the potential speed of the air vehicle. The future position area of the air vehicle 222 may be further determinable according to class information of the air vehicle 222. Class information of the air vehicle 222 may include a maximum velocity (Vₘₐₓ) of the air vehicle 222 and/or a thrust/weight ratio of the air vehicle.

The maximum velocity (Vₘₐₓ) attainable by the air vehicle 222 may be determinable based upon a zoom dive maneuver of the air vehicle. In an exemplary embodiment, the maximum velocity (Vₘₐₓ) attainable by the air vehicle 222, neglecting drag, may be determinable according to the air vehicle's potential and kinetic energy. The determination of the air vehicle's maximum velocity (Vₘₐₓ) via a zoom dive maneuver assumes a dragless zoom dive (a perfect transfer from potential to kinetic energy). Some air vehicles may have sufficient thrust/weight ratios to also accelerate significantly at constant altitude.

In an illustrative example of the determination of the future position area of the air vehicle 222, the air vehicle 222 may be located at a coordinate position (X,Y,Z) (0,0,0) at time t=0. Where the maximum future time for consideration (tₘₐₓ) is greater than 30 seconds, then the air vehicle 222 will be capable of traveling for the maximum future time for consideration (tₘₐₓ) at the maximum velocity attainable (Vₘₐₓ), in a straight line without altitude change, a straight zoom dive or zoom climb maneuver, or any combination thereof or variation therebetween.

The future position area of the air vehicle 222 may also be based on a temporal uncertainty of the air vehicle 222. For instance, an air vehicle 222 may include a transponder configured to report the position and speed of the air vehicle once every 1 to 10 seconds. Thus, a determination of the future position area of the air vehicle 222 at time (t) may account for the passage of time (t+s) since the position and speed of an air vehicle 222 was last reported in determining the future position area of the air vehicle 222. Accordingly, a determination of the air vehicle future position area radius may include the sum of the following: (1) Vₘₑₐₙ tₘₐₓ; (2) Vₗₐₛₜ (device time-time of last reported position); and (3) air vehicle positional uncertainty or expected error, which includes temporal uncertainty in the launch time.

The method 100 may include a two-step launch parameter validation system that operates in conjunction with the designator interface 122 to provide enhanced safety and operational reliability. In this validation system, a first set of launch parameters may be provided to the launch unit 106 prior to launch 102 through the designator interface 122. The first set of launch parameters may include predetermined values for expected launch characteristics such as initial velocity, acceleration profile, spin rate, air pressure readings, and elapsed time thresholds. These parameters may be determined based on the class 190 of the launch unit 106, the fuze 192 configuration, environmental conditions within the potential area 152, and the specific trajectory requirements for reaching the designated target 126. The first set of launch parameters may be transmitted from the first electronic device 114 to the launch unit 106 via the secure network 110 as part of the authorization signal 214, ensuring that the launch unit 106 has the necessary reference data for subsequent validation operations.

After the launch 102 is initiated, the launch unit 106 may autonomously measure a second set of launch parameters using onboard sensors and measurement systems. The second set of launch parameters may include real-time measurements of actual velocity, acceleration vectors, spin characteristics, air pressure variations, and elapsed time since launch initiation. In some aspects, the launch unit 106 may continuously monitor these parameters during the initial phase of flight, typically within the first few seconds after launch 102. The measurement system may include inertial measurement units (IMUs), pressure sensors, gyroscopes, accelerometers, and timing circuits that provide accurate real-time data regarding the launch unit's actual performance characteristics. The second set of launch parameters may be collected at predetermined intervals, such as every 100 milliseconds, to ensure comprehensive monitoring of the launch unit's behavior during the critical initial flight phase.

The launch unit 106 may then perform a comparison operation between the first set of launch parameters and the second set of launch parameters to confirm an intended launch status. This comparison may involve evaluating whether the measured parameters fall within acceptable tolerance ranges of the predetermined parameters, accounting for expected variations due to environmental factors, manufacturing tolerances, and operational conditions. In some embodiments, the comparison may utilize weighted algorithms that prioritize certain parameters over others based on their criticality to mission success. If the comparison indicates that the measured parameters deviate significantly from the expected parameters beyond predetermined thresholds, the system may automatically disarm the launch unit 106 to prevent unintended consequences. Conversely, if the comparison confirms that the launch unit 106 is performing within expected parameters, the system may proceed with the intended mission profile, including deployment of guidance systems, wing and fin configurations, and target acquisition protocols.

In alternative embodiments, the validation system may incorporate redundant verification loops that perform multiple comparison cycles during different phases of the launch sequence. For example, a first validation may occur immediately after launch initiation, a second validation may occur during the ascent phase, and a third validation may occur during the transition to guided flight. The designator interface 122 may provide real-time feedback to the user 128 regarding the validation status, displaying confirmation indicators when parameters are within acceptable ranges or alert notifications if validation failures occur. In some aspects, the system may allow for manual override capabilities through the external mechanical interface 240, enabling authorized users to intervene in the validation process under specific operational circumstances. The validation system may also integrate with the airspace deconfliction status 220 determination, ensuring that parameter validation occurs in coordination with collision avoidance protocols to maintain comprehensive operational safety throughout the launch sequence.

In some aspects, the designator interface 122 may support image-based terminal guidance by storing or displaying an initial image of the target area received from one or more data sources 146. The initial image may be captured and transmitted from various sources including aerial vehicles 164, orbital vehicles 170, or deployable nodes 154 equipped with optical sensors. The designator interface 122 may receive the initial image through the secure network 110 and store it within the visual display 124 for reference during mission execution. In some embodiments, the initial image may include geolocation data, timestamp information, and target designation markers that correspond to the user input 130 designating the target 126. The designator interface 122 may process the initial image to extract distinctive features, landmarks, or reference points that may be used for subsequent comparison operations during the launch unit's flight path.

During flight of the launch unit 106, the designator interface 122 may receive real-time captured images transmitted from the launch unit 106 via the secure network 110. The launch unit 106 may be equipped with onboard imaging systems that capture successive images of the target area as the launch unit 106 approaches the designated target 126. The designator interface 122 may perform image comparison operations between the transmitted images and the stored initial image to assess trajectory alignment and impact accuracy. In some aspects, the comparison may utilize image processing algorithms that analyze pixel patterns, edge detection, feature matching, or correlation coefficients to determine the degree of alignment between the captured images and the initial reference image. The designator interface 122 may display the comparison results within the visual display 124, providing real-time feedback to the user 128 regarding the launch unit's guidance performance and expected impact precision.

In alternative embodiments, the designator interface 122 may overlay guidance information within the field of view 148 to enhance user oversight of autonomous guidance operations. The overlay information may include trajectory prediction lines, impact probability circles, deviation indicators, or correction vectors that are superimposed on the visual display 124. The designator interface 122 may generate these overlays based on the image comparison results and real-time telemetry data received from the launch unit 106. In some cases, the user 128 may interact with the overlaid guidance information through the external mechanical interface 240 to provide manual corrections or adjustments to the launch unit's flight path. The designator interface 122 may also display confidence metrics, range-to-target information, and estimated time-to-impact data alongside the image feeds, enabling comprehensive situational awareness throughout the terminal guidance phase. The overlay system may adapt dynamically based on environmental conditions, target movement, or changes in mission parameters, ensuring that the displayed guidance information remains accurate and relevant throughout the engagement sequence.

The method 100 may include a step of capturing 224 an impact information 226 corresponding to an observed point-of-impact 228 of the launch unit 106 within the field-of-view 148. The sensor 150 associated with the data source 146 or any of the plurality of electronic devices 112 may capture information indicating an impact of the launch unit 106. In some aspects, the capturing 224 of the impact information 226 may include identifying 230 the observed point-of-impact 228 of the launch unit 106. This observed point-of-impact 228 may be displayed to the user 128 and may be presented in the field-of-view 148. Identifying 230 the observed point-of-impact 228 may include determining a geolocation 180 of the observed point-of-impact 228 and comparing the observed point-of-impact 228 to the geolocation 180 of the target 126 as designated by the user input 130. By comparing the observed point-of-impact 228 to the target 126, the step of capturing 224 the impact information 226 may also generate an impact error 232, which represents the deviation of the actual impact from the intended impact. Subsequent launches may account for the impact error 232. Additionally, the step of designating 176 the target 126 may account for the impact error 232.

In an exemplary aspect, the method 100 may include a step of modifying 234 a second launch signal 236 with the impact error 232 and transmitting the second launch signal 236 from the first electronic device 114 to the second electronic device 188 available for launch via the secure network 110. The second launch signal 236 may thus compensate for the impact error 232 and provide the subsequent launch of the launch unit 106 is closer to the target 126 than the observed point-of-impact 228 of the earlier launch unit 106.

In some aspects, the first electronic device 114 may include an external mechanical interface 240 that the user 128 may interact with to perform various steps disclosed above through the designator interface 122. In an exemplary aspect, the user 128 may interact with the external mechanical interface 240 for any number of steps, including designating 176 the target 126, determining 194 the targetable range 196 if the at least one portable launch assembly 104 and/or the launch unit 106, ascertaining 204 the second electronic device 188 available for launch, determining 206 the launch parameter 208, and providing 212 the real-time authorization signal 214.

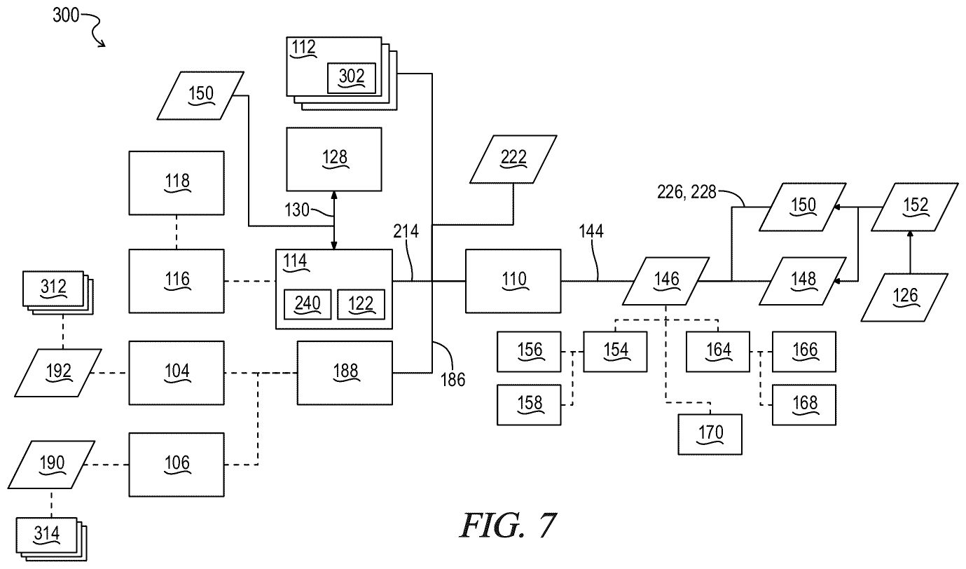

FIG. 7 illustrates an aspect of the system 300 for executing the method 100. The system 300 may include the plurality of electronic devices 112. Each of the plurality of electronic devices 112 may include a communication unit 302 configured to selectively communicate with other of the plurality of electronic devices 112 connected through the secure network 110. The plurality of electronic devices 112 may include the first electronic device 114, the second electronic device 188, and the data source 146 as described herein above. The first electronic device 114 may include or be operatively coupled to the designator interface 122 to allow the user 128 to operate the first electronic device 114 and perform various steps in designating the target and executing the launch. The second electronic device 188 may be operatively coupled to and located at the at least one portable launch assembly 104 and may further be communicatively coupled to the first electronic device 114 in order to transmit the launcher signal 186 to the first electronic device 114. The data source 146 may be communicatively coupled with the first electronic device 114 to provide the target signal 144 to the first electronic device 114.

The exemplary aspect of the plurality of electronic devices 112 illustrated in FIG. 3 depicts the designator interface 122 with selectable graphical icons 134. The designator interface 122 may include the visual display 124 for displaying any information necessary for the user 128 to receive and interact with to perform the method 100. The designator interface 122 may also provide the graphical user interface 132, with the graphical icons 134, as the primary form of interaction with the visual display 124 to perform actions through the designator interface 122. The graphical icons 134 displayed within the visual display 124 may be provided as a plurality of graphical icons 134, each of which may be selectable by the user 128. In exemplary aspects, a first portion 304 of the graphical icons 134 may be selectable to accomplish the step of designating 176 the target 126 within the field-of-view 148. A second portion 306 of the graphical icons 134 may be selectable to display the at least one portable launch assembly 104 that is available for the launch 102. A third portion 308 of the graphical icons 134 may be selectable to designate one or more of the at least one portable launch assembly 104 to be utilized for the launch 102. A fourth portion 310 of the graphical icons 134 may be selectable to transmit the real-time authorization signal 214 to whichever of the at least one portable launch assembly 104 designated for launch. Upon the transmission of the real-time authorization signal 214, the at least one portable launch assembly 104 may be authorized for an autonomous launching 216 of the launch unit 106.

As disclosed above, the first electronic device 114 may include the external mechanical interface 240 operatively coupled to the designator interface 122, so that the user 128 may interact with to perform actions through the designator interface 122. The external mechanical interface 240 may allow for the user input 130 to interact with the graphical user interface 132. In an exemplary aspect, the external mechanical interface 240 may be operable to provide the selection of the first portion 304, the second portion 306, the third portion 308, and the fourth portion 310 of the graphical icons 134.

The system 300 may also include the fuze 192 associated with the launch unit 106. In some aspects, the system 300 may be provided with a plurality of selectable fuzes 312. The plurality of selectable fuzes 312 may include different types of the fuze 192 that be individually selectable for any one or more of the launch unit 106. Similarly, the launch unit 106 may include a plurality of selectable classes 314 that are associated with the launch unit 106. In some aspects, the visual display 124 will display a fifth portion 316 of the graphical icons 134 that provides the selection of the plurality of selectable fuzes 312 and the plurality of selectable classes 314. The fifth portion 316 will allow the user 128 to indicate a particular round of the launch unit 106 to designate for the launch 102 and a particular fuze 192 associated with the launch unit 106 to be used for the launch 102.

To facilitate the understanding of the aspects described herein, a number of terms have been defined above. The terms defined herein have meanings as commonly understood by a person of ordinary skill in the areas relevant to the present disclosure. The terminology herein is used to describe specific aspects of the disclosure, but their usage does not delimit the disclosure, except as set forth in the claims.

The term “user” as used herein unless otherwise stated may refer to an operator, an autonomous system, or any other person or entity as may be, e.g., associated with the plurality of electronic devices 112, the at least one portable launch assembly 104, the system 300, a network, and/or an administrator.

The term “launch” or “launched,” as used in connection with the launch unit 106, may refer to a launch of the launch unit 106 from the surface into the airspace over the area surround the at least one portable launch assembly 104 and/or the target 126. The launch unit 106 of the at least one portable launch assembly 104 may be launched from the surface into the airspace by dispatch or vertical lift-off, including through rotor-based movement of propellers (e.g., drone), or by propulsion, ejection, or discharge, such as projectiles fired from a barrel or tube (e.g., artillery equipment configured to mitigate avalanche activity).

The term “processor” as used herein may refer to at least general-purpose or specific-purpose processing devices, such as a central processing unit, and/or logic as may be understood by one of skill in the art, including but not limited to a microprocessor, a microcontroller, a state machine, and the like. The processor can also be implemented as a combination of computing devices, e.g., a combination of a digital signal processor (DSP) and a microprocessor, a plurality of microprocessors, one or more microprocessors in conjunction with a DSP core, or any other such configuration.

It is understood that various operations, steps, or algorithms, including the method 100, as described in connection with the system 300, including (without limitation) the one or more electronic devices 112 (including those of the one or more electronic devices associated with the at least one portable launch assembly 104), an administrator, or alternative devices or computer structures or hierarchies, can be embodied directly in hardware, in a computer program product such as a software module executed by a processor or any process related to, or embodied by, the foregoing. The computer program product can reside in a storage, which may include RAM memory, flash memory, ROM memory, EPROM memory, EEPROM memory, registers, hard disk, a removable disk, or any other form of computer-readable medium known in the art.

Terms such as “a,” “an,” and “the” are not intended to refer to only a singular entity, but rather include the general class of which a specific example may be used for illustration.

The phrases “in one aspect,” “in optional aspect(s),” and “in an exemplary aspect,” or variations thereof, as used herein does not necessarily refer to the same aspect, although it may.

As used herein, the phrases “one or more,” “at least one,” “at least one of,” and “one or more of,” or variations thereof, when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item B and item C.

Conditional language used herein, such as, among others, “can,” “might,” “may,” “e.g.,” and the like, unless specifically stated otherwise, or otherwise understood within the context as used, is generally intended to convey that certain aspects include, while other aspects do not include, certain features, elements, and/or states. The conditional language is not generally intended to imply that features, elements and/or states are in any way required for one or more aspects or that one or more aspects necessarily include logic for deciding, with or without author input or prompting, whether these features, elements and/or states are included or are to be performed in any particular aspect. Thus, such conditional language is not generally intended to imply that features, elements, and/or states are in any way required for one or more aspects, whether these features, elements, and/or states are included or are to be performed in any particular aspect.

The previous detailed description has been provided for the purposes of illustration and description. Thus, although there have been described particular aspects of a new and useful disclosure, it is not intended that such references be construed as limitations upon the scope of this disclosure except as set forth in the following claims. Thus, it is seen that the apparatus of the present disclosure readily achieves the ends and advantages mentioned as well as those inherent therein. While certain preferred aspects of the disclosure have been illustrated and described for present purposes, numerous changes in the arrangement and construction of parts and steps may be made by those skilled in the art, which changes are encompassed within the scope and spirit of the present disclosure as defined by the appended claims.

We claim:

1. A method of executing a launch of at least one portable launch assembly configured to launch a launch unit, the method comprising:
selectively forming a secure network comprising a plurality of electronic devices, where a first electronic device of the plurality of electronic devices comprises a designator interface configured to generate a visual display of a target to a user and receive a user input designating the target;
transmitting, via the secure network and from a data source of the plurality of electronic devices, a target signal to the first electronic device;
displaying, via the designator interface, a field of view associated with the target signal;
designating, via the designator interface, the target within the field of view;
receiving, at the first electronic device and via the secure network, a launcher signal representative of at least one of a second electronic device of the plurality of electronic devices, the second electronic device is associated with the at least one portable launch assembly, the launch unit, or a combination thereof;
ascertaining, via the designator interface, the second electronic device available for launch, wherein ascertaining is at least based on the target signal and the launcher signal;
providing, via the designator interface and the secure network, a real-time authorization signal to the second electronic device available for launch;
autonomously launching the launch unit from the at least one portable launch assembly based at least upon the real-time authorization signal; and
capturing, via the designator interface, an impact information corresponding to a point of impact of the launch unit within the field of view.

2. The method of claim 1, wherein the step of designating the target further comprises determining a geolocation of the target.

3. The method of claim 1, wherein the step of transmitting the target signal comprises:
wirelessly transmitting the target signal from a data source remotely located from the first electronic device, wherein the data source comprises a deployable node, an aerial vehicle, an orbital vehicle, an optical instrument, or a combination thereof; and/or
transmitting the target signal from the data source via a physical connection, wherein the data source comprises an optical instrument.

4. The method of claim 1, wherein the step of ascertaining the second electronic device available for launch comprises determining, via the designator interface, a launch parameter, where the launch parameter comprises determination of the at least one portable launch assembly, a class of the launch unit, a fuze associated with the launch unit, or a combination thereof.

5. The method of claim 4, wherein determining the launch parameter occurs simultaneous with viewing the target through the designator interface.

6. The method of claim 4, wherein determining the launch parameter further comprises selecting the class of the launch unit prior to selecting the fuze associated with the launch unit.

7. The method of claim 1, wherein:
the first electronic device comprises an external mechanical interface; and
the steps of designating the target, ascertaining the second electronic device available for launch, and providing the real-time authorization signal are executable via the external mechanical interface.

8. The method of claim 1, wherein:
the step of receiving the launcher signal further comprises:
receiving a signal representative of a geolocation of the second electronic device; and
receiving a signal representative of a class of the launch unit and a fuze associated with the launch unit; and
the step of ascertaining the second electronic device available for launch further comprises determining a targetable range of at least one of the second electronic device based upon the signal representative of the geolocation of the second electronic device and the signal representative of the class of the launch unit.

9. The method of claim 2, wherein:
the step of designating the target further comprises viewing, via the designator interface, the target via direct line of sight; and
determining the geolocation of the target is based on a geolocation data associated with the first electronic device and a sensor associated with the first electronic device.

10. The method of claim 1, wherein the step of receiving the launcher signal further comprises:
determining a targetable range of the at least one portable launch assembly, the launch unit, or a combination thereof;
generating an engageable launcher status based on comparing the targetable range of the at least one portable launch assembly, the launch unit, or a combination thereof to the target signal; and
modifying the launcher signal with the engageable launcher status.

11. The method of claim 1, wherein the step of receiving the launcher signal is based on a class of the launch unit, a fuze associated with the launch unit, or a combination thereof.

12. The method of claim 1, wherein the step of autonomously launching the launch unit further comprises:
dynamically determining an airspace deconfliction status associated with the launch unit and an air vehicle.

13. The method of claim 1, wherein the step of capturing the impact information further comprises:
identifying, via the designator interface, the point of impact of the launch unit, where the step of identifying the point of impact comprises determining a geolocation of the point of impact; and
comparing the point of impact of the launch unit to the user input designating the target to determine an impact error.

14. The method of claim 13, further comprising:
modifying a second launch signal with the impact error; and
transmitting, via the secure network, the second launch signal from the first electronic device to the second electronic device available for launch.

15. The method of claim 1, wherein the designator interface further comprises a second designator interface;
the step of ascertaining the second electronic device available for launch occurs distinctly from the designator interface and further comprises selection of a class of the launch unit, a fuze associated with the launch unit, or a combination thereof.

16. A system for executing a launch of at least one portable launch assembly configured to launch a launch unit, comprising:
a plurality of electronic devices, each of the plurality of electronic devices comprising a communication unit configured to selectively communicatively couple each of the plurality of electronic devices to one another such that each of the plurality of electronic devices are in association with one another;
a first electronic device of the plurality of electronic devices, the first electronic device comprising a designator interface;
a second electronic device of the plurality of electronic devices, the second electronic device being operatively and physically coupled with the at least one portable launch assembly, the second electronic device being communicatively coupled with the first electronic device;
a data source of the plurality of electronic devices, the data source comprising a sensor with a field of view, the data source being communicatively coupled with the first electronic device; and
the designator interface further comprising:
a visual display for displaying information; and
a plurality of graphical icons displayed within the visual display, each of the plurality of graphical icons selectable;
wherein, upon selection of a first portion of the plurality of graphical icons, an object within the field of view is designated as a target;
wherein, upon selection of a second portion of the plurality of graphical icons, one or more of the at least one portable launch assembly is displayed as an available portable launch assembly;
wherein, upon selection of a third portion of the plurality of graphical icons, the launch unit is designated for launch from the available portable launch assembly;
wherein, upon selection of a fourth portion of the plurality of graphical icons, the first electronic device transmits a real-time authorization signal to the second electronic device to autonomously launch the launch unit.

17. The system of claim 16, wherein the first electronic device comprises:
an external mechanical interface operatively coupled to the designator interface;
wherein the external mechanical interface is operable to provide the selection of the first, second, third, and fourth portions of the plurality of graphical icons.

18. The system of claim 16, further comprising:
a plurality of selectable fuzes associated with the launch unit; and
the launch unit further comprising a plurality of selectable classes of the launch unit;
wherein, upon selection of a fifth portion of the plurality of graphical icons, a class of the plurality of selectable classes and a fuze of the plurality of selectable fuzes are associated with the launch unit designated for launch.

19. The system of claim 16, wherein the data source comprises:
a deployable node, an aerial vehicle, an orbital vehicle, an optical instrument physically coupled to the first electronic device, or a combination thereof.
